(19) United States
(12) Patent Application Publication
(10) Pub. No.: US 2024/0322493 A1
(43) Pub. Date: Sep. 26, 2024

(54) FITTING STRUCTURE

(71) Applicant: Yazaki Corporation, Tokyo (JP)

(72) Inventors: Masayuki SAITO, Makinohara-shi (JP); Hiromasa KUBOTA, Fujieda-shi (JP)

(73) Assignee: Yazaki Corporation, Tokyo (JP)

(21) Appl. No.: 18/608,077

(22) Filed: Mar. 18, 2024

(30) Foreign Application Priority Data
Mar. 20, 2023 (JP) 2023-044219

(51) Int. Cl. H01R 13/642; H01R 13/639

(52) U.S. Cl. CPC H01R 13/642; H01R 13/639

(57) ABSTRACT

In a first housing configuring a fitting structure, an accommodation portion opening in a front-rear direction and configured to accommodate a second housing, and an incorrect fitting-prevention rib protruding toward an inside of the accommodation portion and extending in a fitting direction are provided therein. In the second housing fitting with the first housing, a fitting concave portion being concave in a protrusion direction of the incorrect fitting-prevention rib is provided, while a front retainer having a fitting groove being concave in the protrusion direction is attached to the second housing. The fitting concave portion has a predetermined width in an up-down direction and is configured to receive the incorrect fitting-prevention rib inside the accommodation portion, and the fitting groove and the incorrect fitting-prevention rib are fitted with each other within the width of the fitting concave portion.

### TECHNICAL FIELD

The present invention relates to a fitting structure.

### BACKGROUND ART

A fitting structure (for example, referring to Patent Document 1) including a first housing and a second housing formed in a cylindrical shape and into which the first housing is inserted along a connection direction is known. According to a connector disclosed in Patent Document 1, an incorrect fitting-prevention rib is provided in the first housing, and a concave groove for fitting the incorrect fitting-prevention rib therein is provided in the second housing. At the time of connecting the first housing and the second housing, the incorrect fitting-prevention rib and the concave groove are engaged with each other such that an incorrect fitting of the first housing with respect to the second housing is prevented.

### CITATION LIST

### Patent Documents

[Patent Document 1] JP 2007-242416A

### SUMMARY OF THE INVENTION

### Technical Problem

However, according to the above-described electric connector, preventing the incorrect fitting of the first housing and the second housing is devised by fitting the incorrect fitting-prevention rib and the concave groove one-on-one. Accordingly, in a case in which the shape and the arrangement of the incorrect fitting-prevention rib varies due to a change in the type of the first housing, it is necessary to manufacture the second housing anew with the shape and the arrangement of the concave groove being changed such that various costs, including the construction of new molds and the like, will increase.

An object of the present invention is to achieve a fitting structure of the housing to prevent the incorrect fitting while reducing the manufacturing cost of the housing.

### Solution to Problem

In order to solve the above-mentioned technical problem, a fitting structure for fitting a first housing of a first connector and a second housing of a second connector that is connected to the first connector along a fitting direction, includes an accommodation portion and an incorrect fitting-prevention rib provided in the first housing, wherein the accommodation portion opens in the fitting direction and is configured to accommodate the second housing, and the incorrect fitting-prevention rib protrudes toward an inside of the accommodation portion and extends in the fitting direction; a fitting concave portion provided in the second housing to be concave in a protrusion direction of the incorrect fitting-prevention rib; and an incorrect fitting-prevention member attached to the second housing and including a fitting groove being concave in the protrusion direction, wherein the fitting concave portion has a predetermined width in an intersection direction intersecting with the fitting direction and configured to receive the incorrect fitting-prevention rib inside the accommodation portion, and the fitting groove and the incorrect fitting-prevention rib are fitted with each other within the width of the fitting concave portion.

### Effect of the Invention

According to the present invention, it is possible to achieve a fitting structure of the housing to prevent the incorrect fitting while reducing the manufacturing cost of the housing.

### BRIEF DESCRIPTION OF THE DRAWINGS

FIG. 1 is a perspective view showing a first housing configuring a fitting structure according to an embodiment of the present invention.

FIG. 2 is a perspective view showing a second housing corresponding to the first housing.

FIG. 3 is an exploded perspective view showing the second housing and a front retainer.

FIG. 4 is an exploded perspective view showing the second housing and a side retainer.

FIG. 5 is a front view showing the second housing in FIG. 2 viewed from a front side.

FIG. 6A is a side view showing the second housing in FIG. 2 viewed from a right side.

FIG. 6B is a side view showing the second housing in FIG. 2 viewed from a left side.

FIG. 7 is a rear view showing the first housing and the second housing in a fitted state viewed from a rear side.

FIG. 8A is a cross-sectional view showing the housing at the start of connection taken along a line A-A in FIG. 7.

FIG. 8B is a cross-sectional view showing the housing at the start of connection taken along a line B-B in FIG. 7.

FIG. 9 is a partial enlarged view showing an area A in FIG. 8A.

FIG. 10A is a cross-sectional view showing the housing during the connection taken along the line A-A in FIG. 7.

FIG. 10B is a cross-sectional view showing the housing during the connection taken along the line B-B in FIG. 7.

FIG. 11 is a partial enlarged view showing an area B in FIG. 10B.

FIG. 12A is a cross-sectional view showing the housing during the connection taken along the line A-A in FIG. 7.

FIG. 12B is a cross-sectional view showing the housing during the connection taken along the line B-B in FIG. 7.

FIG. 13A is a cross-sectional view showing the housing in a state when the connection is completed taken along the line A-A in FIG. 7.

FIG. 13B is a cross-sectional view showing the housing in the state when the connection is completed taken along the line B-B in FIG. 7.

### DESCRIPTION OF EMBODIMENTS

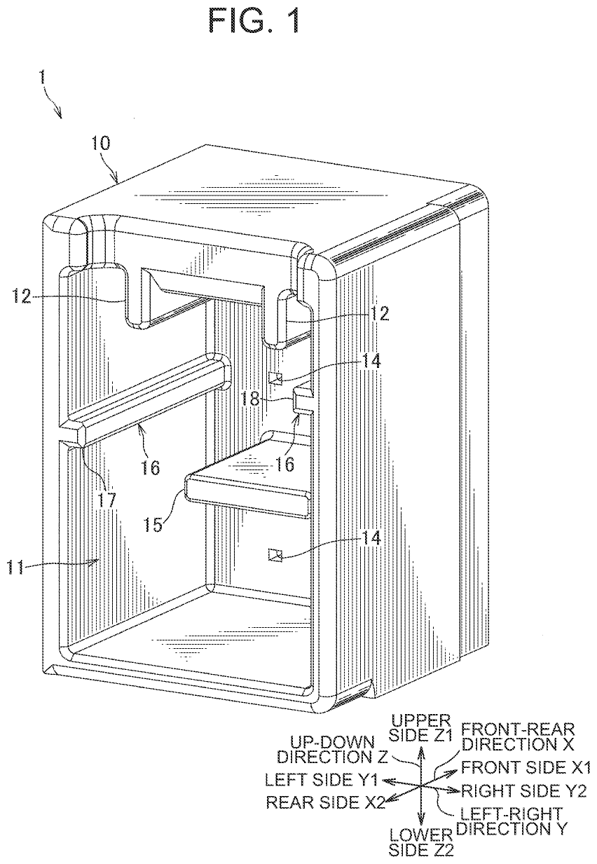

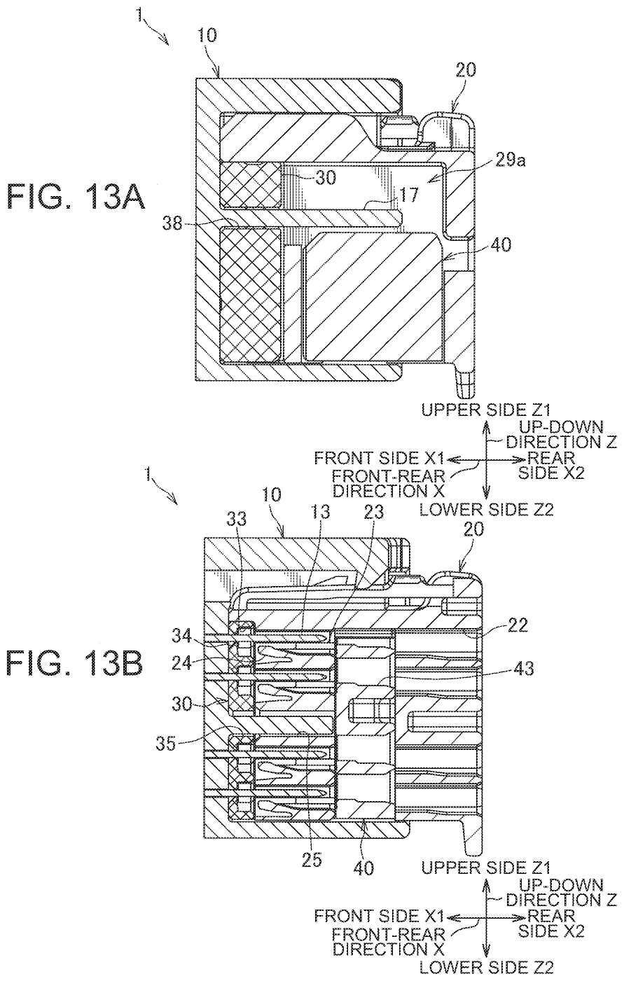

Hereinafter, an embodiment of a fitting structure will be described based on FIG. 1 to FIG. 13B. According to the present embodiment, in the figures, an arrow X, an arrow Y, and an arrow Z are directions perpendicular to each other. The arrow X indicates a fitting direction of a first housing 10 of a first connector and a second housing 20 of a second connector being connected to the first connector configuring a fitting structure 1. In the present description, this fitting direction is recorded as a “front-rear direction X”, one side in the front-rear direction X is recorded as a “front side X1”, and the other side therein is recorded as a “rear side X2”. The arrow Y indicates a width direction of the first housing 10 and the second housing 20. The width direction is recorded as a “left-right direction Y”, wherein one side in the left-right direction Y is recorded as a “left side Y1”, and the other side is recorded as a “right-side Y2”. The arrow Z indicates a height direction of the first housing 10 and the second housing 20. The height direction is a direction intersecting with the front-rear direction X. The intersection direction is recorded as a “up-down direction Z”, wherein one side in the up-down direction Z is recorded as an “upper side Z1”, and the other side is recorded as a “lower side Z2”. The definitions of these directions are only for facilitating the description, and they are not used for limiting the directions of the first housing 10 and the second housing 20 in an actual usage state.

The fitting structure 1 is the structure for fitting the first housing 10 and the second housing 20 along the front-rear direction. FIG. 1 is a perspective view showing the first housing 10 according to an embodiment of the present invention. The first housing 10 configures a male connector as the first connector. The first housing 10 is formed into a rectangular box shape using a resin material or the like. Inside the first housing 10, an accommodation portion 11 extending in the front-rear direction X and opening at the rear side X2 is formed therein. The accommodation portion 11 is a portion configured to accommodate the second housing 20, and formed of a substantially rectangular parallelepiped space. A first positioning protrusion 12 protruding toward the lower side Z2 is formed on a wall surface on the upper side Z1 of the first housing 10. Two of the first positioning protrusions 12 are formed by being separated from each other with an interval therebetween in the left-right direction Y. The first positioning protrusion 12 is a protrusion to fit into a positioning groove 21 of the second housing 20 that will be described below, due to this fitting, the position of the second housing 20 with respect to the first housing 10 in the left-right direction Y is determined.

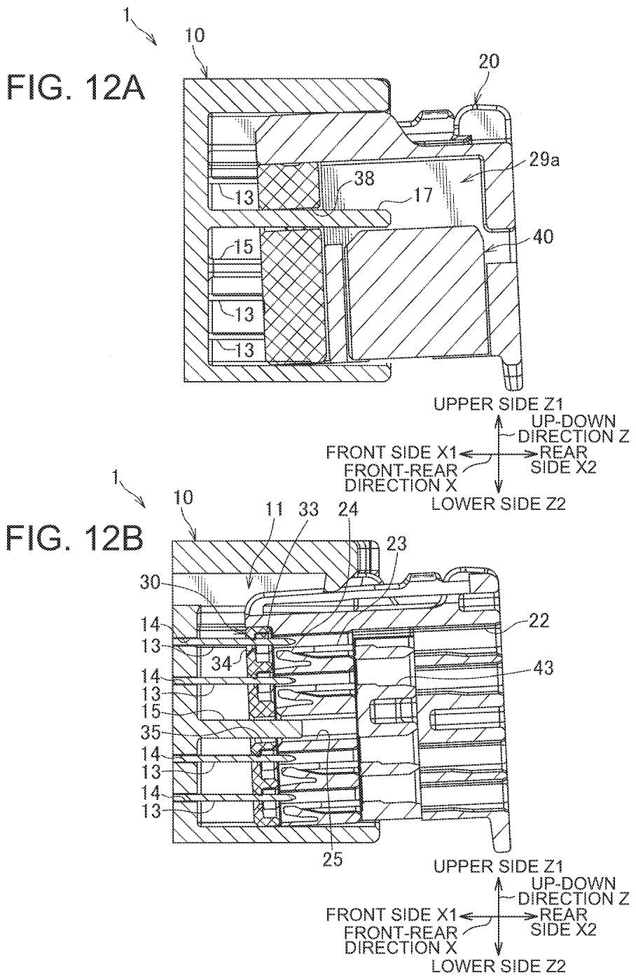

On the wall surface at the front side X1 of the first housing 10, a tab insertion hole 14 penetrating in the front-rear direction X is formed. A tab configuring a front-end portion of a male terminal (mating terminal) 13 is inserted into this tab insertion hole 14 toward the rear side X2 (see FIG. 12B). The tab of the male terminal 13 extends toward the rear side X2 inside the accommodation portion 11. According to the present embodiment, the male terminals 13 are arranged in a matrix with three arranged one by one in the left-right direction Y and four arranged one by one in the up-down direction Z such that there are totally twelve male terminals 13 are accommodated in the accommodation portion 11 and there are twelve of the tab insertions holes 14 formed corresponding thereto. On the wall surface at the front side X1 of the accommodation portion 11, between a portion where the two segments of the tab insertion holes 14 at the upper side Z1 and a portion where the two segments of the tab insertions holes 14 at the lower side Z2, a second positioning protrusion 15 protruding toward the rear side X2 is formed therein.

The second positioning protrusion 15 is configured as a member in a rectangular plate shape extending in the left-right direction Y, and the second positioning protrusion 15 being is insertable into a positioning hole 25 of the second housing 20 described below and a positioning hole 35 of a front retainer 30 described below. Due to the second positioning protrusion 15 being inserted into the positioning hole 25 and the positioning hole 35, the position of the second housing 20 with respect to the first housing 10 in the left-right direction Y and the up-down direction Z is determined. On the wall surfaces of the accommodation portion 11 at the left side Y1 and the right side Y2, incorrect fitting-prevention ribs 16 protruding toward the inside of the accommodation portion 11 in the left-right direction (protrusion direction) Y respectively and extending along the front-rear direction X are formed. The incorrect fitting-prevention rib 16 is a portion fitting with a fitting groove 37 described below and configured to prevent other housing that does not correspond to the first housing 10 (for example, a housing or the like in which the position of the fitting groove 37 is different from that according to the present embodiment) from fitting with the first housing 10.

The incorrect fitting-prevention rib 16 includes a first rib 17 protruding from the wall surface at the left side Y1 of the accommodation portion 11 toward the right side Y2 and a second rib 18 protruding from the wall surface at the right side Y2 of the accommodation portion 11 toward the left side Y1. The first rib 17 is formed with a protruding end portion having cross section in a flat rectangular shape and extends along the front-rear direction X from an end portion at the front side X1 to an end portion at the rear side X2 on the wall surface of the accommodation portion 11 at the left side Y1. The second rib 18 is formed in the same shape with that of the first rib 17, and extends along the front-rear direction X from an end portion at the front side X1 to an end portion at the rear side X2 on the wall surface of the accommodation portion 11 at the right side Y2. The second rib 18 is positioned at the upper side Z1 when compared with the first rib 17.

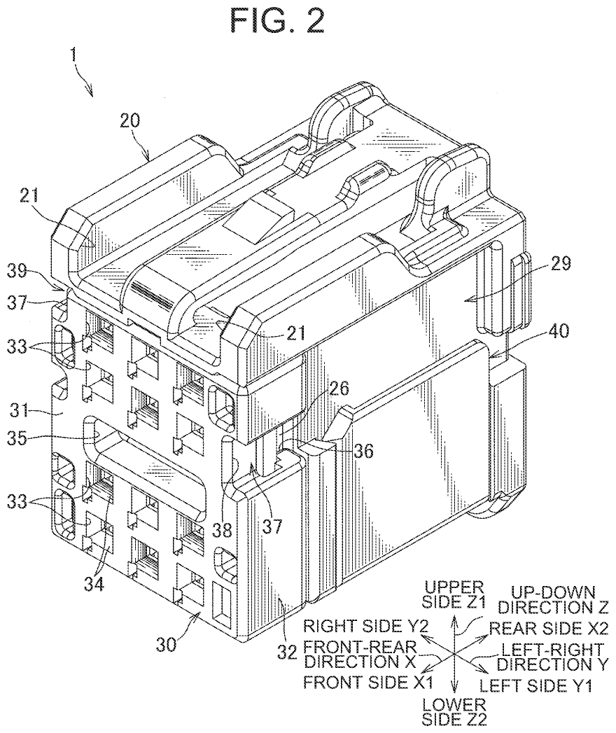

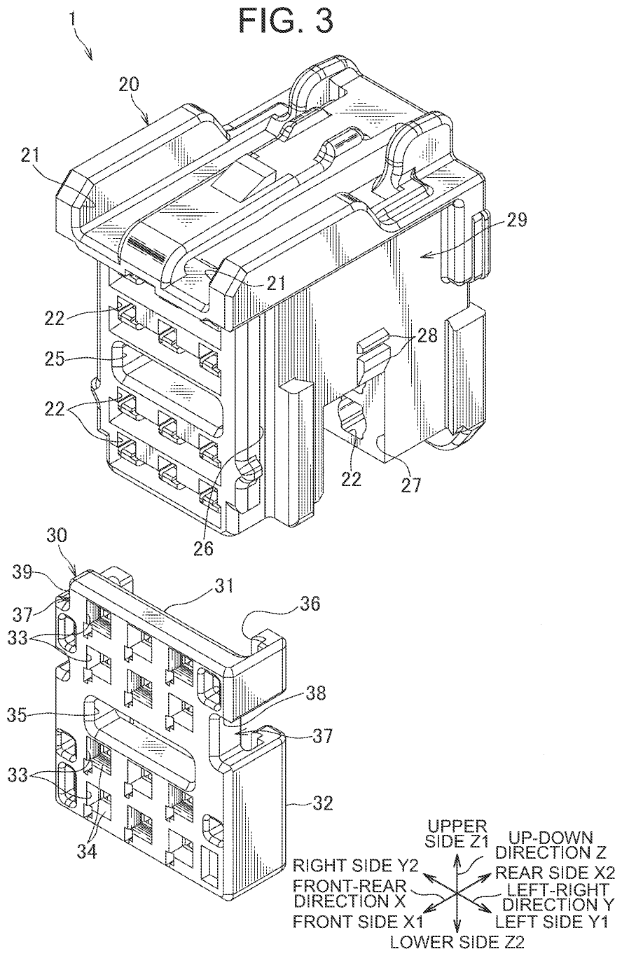

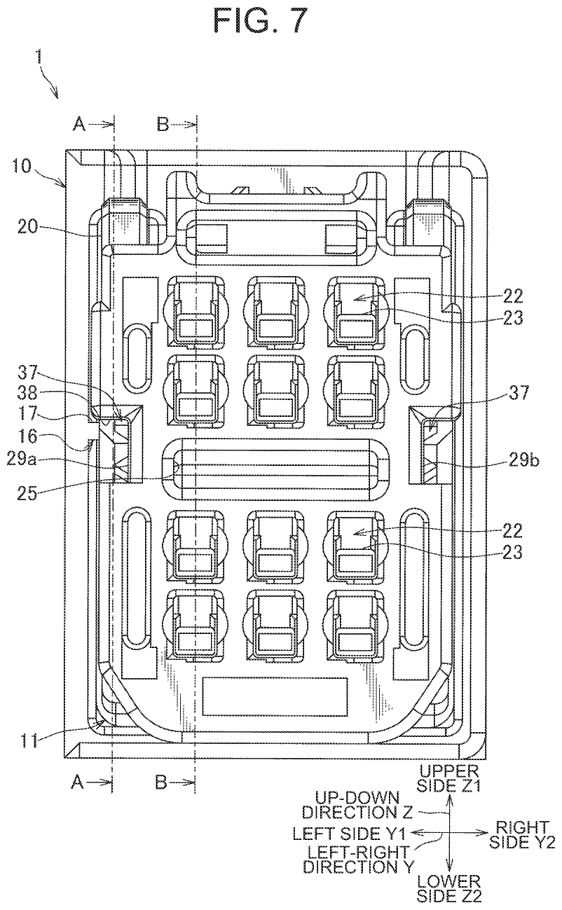

The second housing 20 is a housing configuring a female connector as a second connector to be connected with the above-described male connector. The second housing 20 is formed in a rectangular box shape using a resin material or the like to be able to be accommodated in the accommodation portion 11 of the first housing 10. As shown in FIG. 2, the second housing 20 is configured for a front retainer (incorrect fitting-prevention member) 30 covering the end portion at the front side X1 and a side retainer 40 covering the lower side Z2 and the both sides in the left-right direction Y to be able to be detachably attached thereto. As shown in FIG. 3, on the wall surface of the second housing 20 at the upper side Z1, a positioning groove 21 being concave at the lower side Z2 is formed. The positioning groove 21 is a portion to which the above-described first positioning protrusion 12 is fitted, and there are two of positioning grooves 21 formed to be separated from each other with an interval therebetween in the left-right direction X in correspondence with the first positioning protrusion 12. Inside the second housing 20, a terminal accommodation room 22 penetrating in the front-rear direction X is formed. The terminal accommodation room 22 is a portion for accommodating the female terminal (terminal) 23 that is inserted from the rear side X2 toward the front side X1 (referring to FIG. 7), and there are totally twelve of terminal accommodation rooms 22 formed in a matrix with three arranged one by one in the left-right direction Y and four arranged one by one in the up-down direction Z so as to correspond to the above-described male terminals 13.

As shown in FIG. 12B, inside the terminal accommodation room 22, a lance 24 is formed to stand up diagonally from the wall portion at the lower side Z2 toward the front side X1, and the lance 24 is configured to retain the female terminal 23 so as to prevent a slipping of the female terminal 23 to the front-rear direction X. As shown in FIG. 3, on the wall surface of the second housing 20 at the front side X1, a positioning hole 25 penetrating in the front-rear direction X is formed in a gap between a portion where the two segments of the terminal accommodation rooms 22 at the upper side Z1 are formed and a portion where the three segments of the terminal accommodation rooms 22 at the lower side Z2 are formed. This positioning hole 25 is a portion into which the above-described second positioning protrusion 15 of the first housing 10 is inserted, and the positioning hole 25 together with the second positioning protrusion 15 determine the position of the second housing 20 with respect to the first housing 10 in the left-right direction Y and the up-down direction Z.

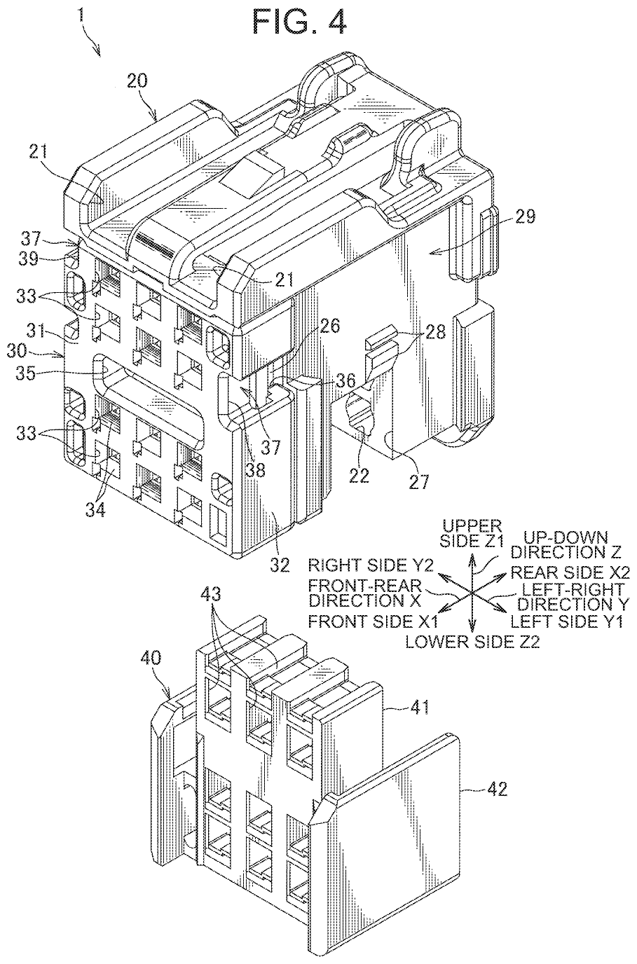

In a portion at the front side X1 of the side wall (side portion) of the second housing 20 at the left side Y1 and the right side Y2, a guiding groove 26 being concave inwardly in the left-right direction Y and extending along the up-down direction Z is formed. This guiding groove 26 is a portion for guiding the front retainer 30 such that the front retainer 30 moves along the up-down direction Z as an attachment direction thereof when attaching the front retainer 30, and opens at the lower side Z2. In the portion at the lower Z2 of the second housing 20, an attachment portion 27 being cut off in a rectangular shape is formed to open at the lower side Z2 and the left-right direction Y. As shown in FIG. 4, the attachment portion 27 is a portion for attaching the side retainer 40. On the two side walls of the second housing 20 in the left-right direction Y, in the portion at the upper side Z1 of the attachment portion 27, a retaining protrusion 28 for retaining the side retainer 40 is formed therein. The retaining protrusion 28 is a protrusion for retaining the side retainer 40 to the second housing 20, and is configured to retain a retained portion of the side retainer 40 that is not shown in figures. Accordingly, a state in which the side retainer 40 is connected to the second housing 20 is maintained.

On the two side walls in the left-right direction Y of the second housing 20, a fitting concave portion 29 being concave inwardly in the left-right direction Y is formed. The fitting concave portion 29 is a concave portion to receive the above-described incorrect fitting-prevention rib 16 of the first housing 10 inside the accommodation portion 11. The fitting concave portion 29 is configured to have a predetermined width in the up-down direction Z with a boundary between the wall portion at the upper side Z1 of the second housing 20 and the side wall as an upper end. The predetermined width refers to a width that is larger than the width of the incorrect fitting-prevention rib 16 in the up-down direction Z. The fitting concave portion 29 is configured by a first concave portion 29a formed on the side wall at the left side Y1 of the second housing 20, and a second concave portion 29b formed on the side wall at the right side Y2 of the second housing 20. The first concave portion 29a receives the first rib 17 of the incorrect fitting-prevention rib 16 in the accommodation portion 11. The second concave portion 29b receives the second rib 18 of the incorrect fitting-prevention rib 16 in the accommodation portion 11.

The front retainer (incorrect fitting-prevention member) 30 is a member being attached to the end portion at the front side X1 of the second housing 20 (end portion at one side in the fitting direction) so as to prevent the slipping of the female terminal 23. As shown in FIG. 3, the front retainer 30 includes a front wall 31 in a rectangular plate shape extending in the left-right direction Y and the up-down direction Z, and a side wall 32 protruding from two end portions in the left-right direction Y of the front wall 31 toward the rear side X2. In the front wall 31, terminal insertion holes 33 penetrating in the front-rear direction X are formed at positions being opposite, in the front-rear direction X, to the positions where the terminal accommodation rooms 22 of the second housing 20 are formed. In other words, there are totally twelve of the terminal insertion holes 33 are formed in the front wall 31. The terminal insertion holes 33 are the portions communicating with the terminal accommodation rooms 22 from the outside, and at the time of fitting the first housing 10 and the second housing 20 with each other, the male terminals 13 of the first housing 10 are inserted therethrough from the outside toward the inside thereof.

In an opening edge portion at the front side X1 of the terminal insertion hole 33, an inclination surface 34 being inclined toward a central portion of the terminal insertion hole 33 is formed. The inclination surface 34 is a portion being in slidingly contact with a front-end portion of the tab of the male terminal 13 when the male terminal 13 is inserted into the terminal accommodation room 22 so as to guide the male terminal 13 into the terminal insertion hole 33. By forming the inclination surface 34, the mating terminal is correctly guided into the terminal accommodation room 22 without colliding with the outside of the terminal insertion hole 33. In the front wall 31, a positioning hole 35 penetrating in the front-rear direction X is formed in a gap between a portion where the two segments of the terminal accommodation rooms 22 at the upper side Z1 are formed and a portion where the two segments of the terminal accommodation rooms 22 at the lower side Z2 are formed. This positioning hole 35 is a portion into which the second positioning protrusion 15 of the first housing 10 is inserted, similar to the above-described positioning hole 25 of the second housing 20. The positioning hole 35 together with the positioning hole 25 and the second positioning protrusion 15 determine the position of the second housing 20 with respect to the first housing 10 in the left-right direction Y and the up-down direction Z.

In an end portion at the rear side X2 of the side wall 32 of the front retainer 30, a guide protrusion 36 formed in a claw shape to protrude toward inwardly in the left-right direction Y is formed. The guide protrusion 36 is inserted from the opening at the lower side Z2 of the guide groove 26 of the first housing 10 and is slidingly movable in the up-down direction Z. Accordingly, the front retainer 30 is attached to the second housing 20 while slidingly moving to the upper side Z1, and the front retainer 30 is detached from the second housing 20 while slidingly moving to the lower side Z2. That is, the front retainer 30 is attached to and detached from the second housing 20 along the up-down direction Z.

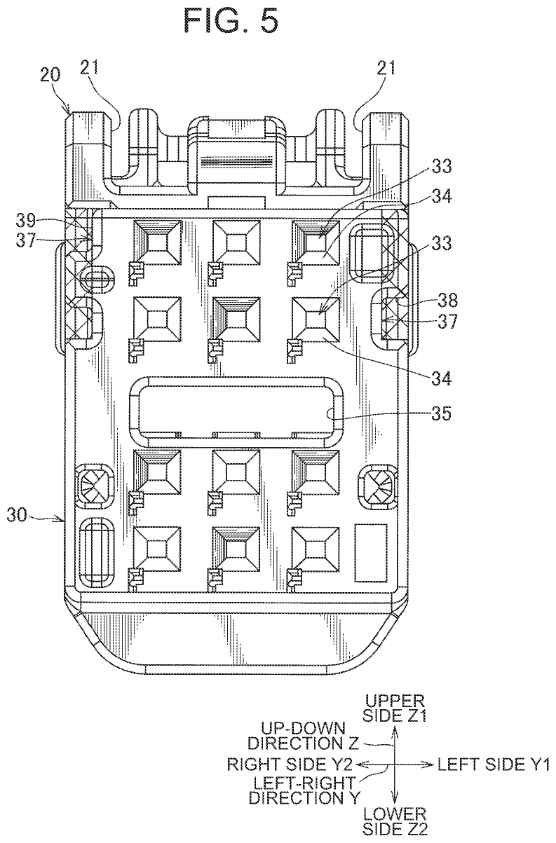

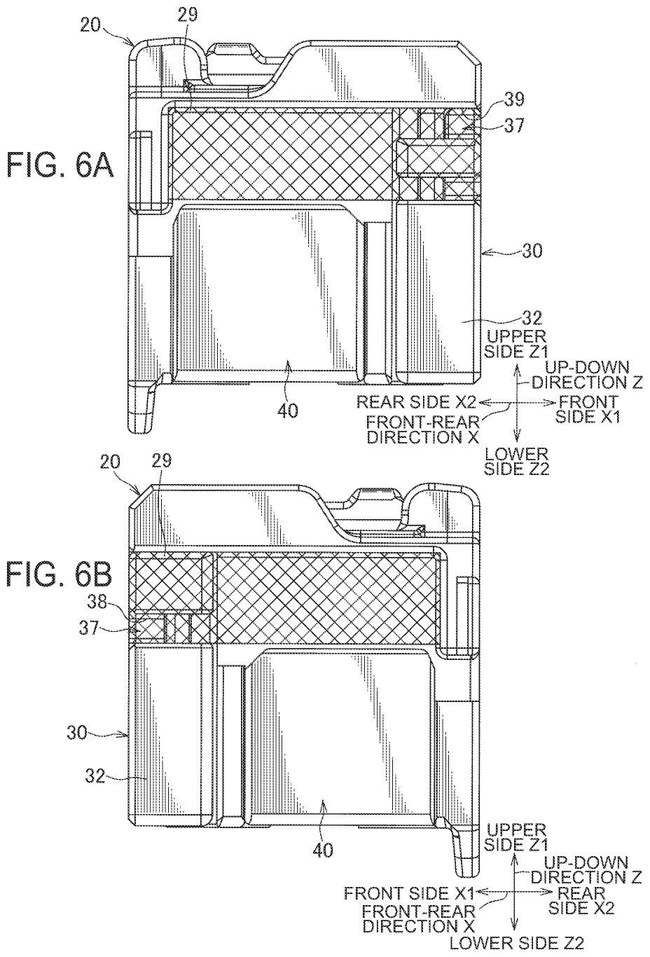

On the side wall 32 of the front retainer 30, a fitting groove 37 being concave inwardly in the left-right direction Y is formed. The fitting groove 37 is a portion fitting with the incorrect fitting-prevention rib 16 within the width of the fitting concave portion 29 when the second housing 20 is fitted with the first housing 10. This fitting groove 37 is formed at any position within the width of the fitting concave portion 29 (that is, in a range between an upper end and a lower end of the fitting concave portion 29) that is shown by hatching in each of FIG. 5, FIG. 6A, and FIG. 6B so as to correspond to the incorrect fitting-prevention rib 16. More specifically, the fitting groove 37 includes a first fitting groove 38 corresponding to the first rib 17 in the incorrect fitting-prevention rib 16, and a second fitting groove 39 corresponding to the second rib 18 in the incorrect fitting-prevention rib 16. As shown in FIG. 6B, the first fitting groove 38 is formed on the side wall 32 at the left side Y1 to open in the front-rear direction X. As shown in FIG. 6A, the second fitting groove 39 is formed on the side wall 32 at the right side Y2 to open in the front-rear direction X, and is positioned at the further upper side Z1 than the first fitting groove 38.

The side retainer 40 is a member being attached to the attachment portion 27 of the second hosing 20. This side retainer 40 is a portion configured to perform the prevention of slipping of the female terminal 23 that is inserted into the terminal accommodation room 22, and the side retainer 40 is fixed inside the attachment portion 27 to be displaceable to a temporarily retaining position and a regular retaining position. The side retainer 40 includes a main body 41 in a rectangular box shape and plate-shaped side arms 42 provided at two ends of the main body 41 in the left-right direction Y. The main body 41 has a temporarily accommodation room 43 communicating with the terminal accommodation room 22 provided therein. When the temporarily accommodation room 43 is in a state in which the side retainer 40 is at the temporarily retaining position, a central axis thereof is coaxial with the central axis of the terminal accommodation room 22 to insert the female terminal 23 therethrough in the front-rear direction X.

On the other hand, in a state in which the side retainer 40 is at the regular retaining position, the central axis thereof is offset from the central axis of the terminal accommodation room 22 such that the female terminal 23 cannot be inserted therethrough and removed. Accordingly, by making the side retainer 40 to move to the regular retaining position, inserting the female terminal 23 by mistake is prevented while preventing the female terminal 23 that has been inside the temporarily retaining room 43 from slipping in the front-rear direction X. The side arm 42 is formed in a plate shape extending in the front-rear direction X and the up-down direction Z. The side arm 42 is a portion to which the retaining protrusion 28 of the second housing 20 is retained, and in a state of attaching the side retainer 40 to the attachment portion 27, the side arm 42 is retained to the retaining protrusion 28 to cover a portion at the lower side Z2 in the side wall of the second housing 20.

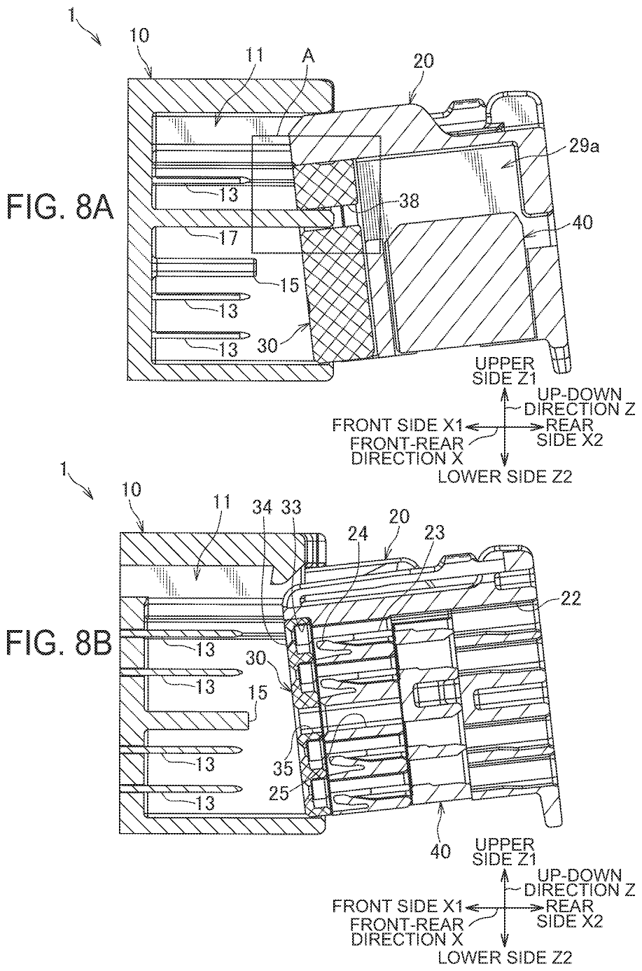

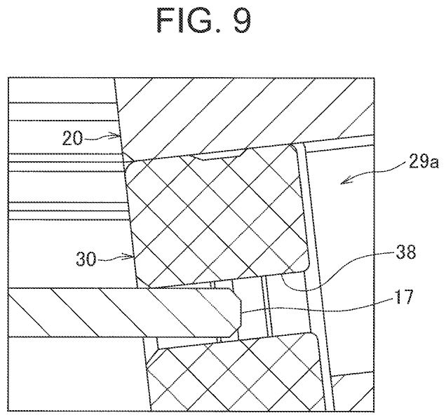

Next, the fitting between the first housing 10 and the second housing 20 will be described. At first, the first housing 10 accommodating the male terminals 13 and the second housing 20 accommodating the female terminals 23 are arranged to face each other in the front-rear direction X, as shown in FIG. 8A and FIG. 8B, the second housing 20 is made toward the front side X1 to fit within the opening of the accommodation portion 11 from the end portion at the front side X1. At this time, as shown in FIG. 9, the end portion at the rear side X2 of the first rib 17 of the first housing 10 is fitted to the first fitting groove 38 of the front retainer 30. Although it is not shown in figures, the end portion of the second rib 18 at the rear side X2 is fitted to the second fitting groove 39 of the front retainer 30. Also, it is noted that the housing that is not corresponding to the first housing 10, that is, the housing without the first fitting groove 38 and the second fitting groove 39, or the housing in which the shape and the arrangement of the first fitting groove 38 and the second fitting groove 39 are different cannot be fitted to the first housing 10. The reason is that the first rib 17 and the second rib 18 are caught by such housing that does not correspond thereto and such housing cannot be moved toward the first housing 10 side any further.

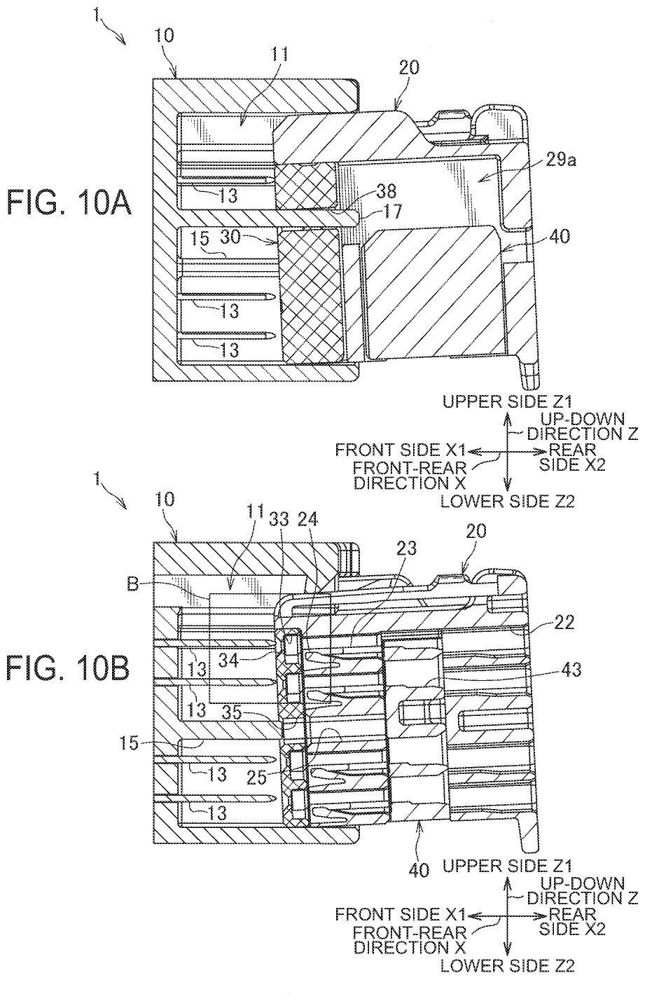

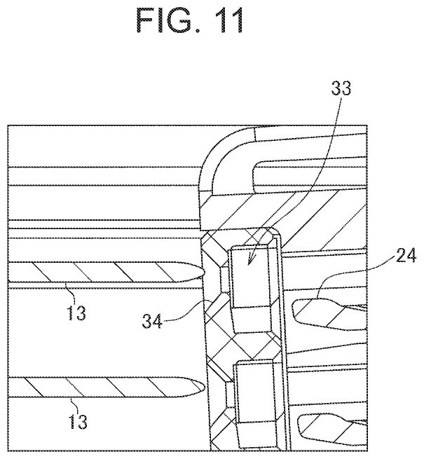

Furthermore, when the second housing 20 is inserted into the first housing 10, as shown in FIG. 10B, the end portion of the second positioning protrusion 15 of the first housing 10 at the rear side X2 starts to be inserted into the positioning hole 35 of the front retainer 30. Accordingly, the position of the second housing 20 with the first housing 10 in the left-right direction Y and the up-down direction Z is determined. As shown in FIG. 11, the end portion of the male terminal 13 at the rear side X2 starts to be inserted into the terminal insertion hole 33 from the front side X1 toward the rear side X2. At this time, the front-end portion of the tab of the male terminal 13 is in slidingly contact with the inclination surface 34 of the terminal insertion hole 33 such that the male terminal 13 is guided by the inclination surface 34 while being inserted into the terminal insertion hole 33. Therefore, when the end portion of the second housing 20 at the front side X1 comes into contact with the inner wall surface of the accommodation portion 11 at the front side X1, the fitting of the first housing 10 and the second housing 20 is completed.

As described above, according to the above-described embodiment, the fitting structure 1 is the structure for fitting the first housing 10 of the first connector and the second housing 20 of the second connector connected with the first connector along the front-rear direction (fitting direction) X. In the first housing 10, the accommodation portion 11 opening at the rear side X2 and configured to accommodate the second housing 20, and the incorrect fitting-prevention rib 16 protruding toward the inside of the accommodation portion 11 and extending in the front-rear direction X are provided. In the second housing 20, the fitting concave portion 29 being concave in the protrusion direction of the incorrect fitting-prevention rib 16 is provided, and the front retainer (incorrect fitting-prevention member) 30 having the fitting groove 37 being concave in the protrusion direction is attached thereto. The fitting concave portion 29 has the predetermined width in the up-down direction Z and receives the incorrect fitting-prevention rib 16 inside the accommodation portion 11. The fitting groove 37 is fitted with the incorrect fitting-prevention rib 16 within the width of the fitting concave portion 29.

According to such an embodiment, it is possible to make the fitting groove 37 of the front retainer 30 and the incorrect fitting-prevention rib 16 to be fitted with each other, while fitting the first housing 10 and the second housing 20 with each other in the front-rear direction X. Accordingly, it is possible to prevent the fitting of the first housing 10 and the second housing 20 by mistake. Also, it is possible for the fitting groove 37 to be fitted with the incorrect fitting-prevention rib 16 at any position within the width of the fitting concave portion 29 of the second housing 20. Accordingly, within the width of the fitting concave portion 29, it is possible to prepare a plurality of patterns of fitting positions and shapes of the incorrect fitting-prevention rib 16 and the fitting groove 37. Accordingly, for example, in a case in which the type of the first housing 10 changes and the arrangement and the shape of the incorrect fitting-prevention rib 16 become different, it is possible to prepare the second housing 20 corresponding to the first housing 10 whose type has been changed by attaching the front retainer 30 in which the arrangement and the shape of the fitting groove 37 is changed to the second housing 20. In this manner, it is unnecessary to manufacture the new second housing 20 such that it is possible to suppress the increase in various costs such as the construction of new molds. Thus, it is possible to reduce the manufacturing cost of the second housing (housing) 20 while achieving the fitting structure to prevent the incorrect fitting.

Also, a plurality of front retainers 30 with various variations in the arrangement and shape of the fitting grooves 37 may be prepared as a set in advance, and the front retainers 30 may be replaced each time when the type of the first housing 10 as the target to be fitted changes. Accordingly, by only changing the variation of the front retainer 30 to be attached thereto, it is possible to attach the second housing 20 to various types of first housing 10 without manufacturing the new second housing 20. Also, according to the above-described embodiment, the front retainer 30 is used as the incorrect fitting-prevention member, however, a member other than the front retainer 30 may be used as the incorrect fitting-prevention member. For example, it is possible to form the fitting groove 37 in the side arm 42 of the side retainer 40 or the like and adopt this member as the incorrect fitting-prevention member.

According to the embodiment, the front retainer 30 is provided to be attachable and detachable along the up-down direction Z. Accordingly, when accommodating the second housing 20 in the accommodation portion 11 of the first housing 10, by fitting the incorrect fitting-prevention rib 16 in the fitting groove 37, the incorrect fitting-prevention rib 16 extends in the front-rear direction X intersecting with the up-down direction Z, that is, the attachment-detachment direction of the front retainer 30. Accordingly, even if the front retainer 30 displaces in the up-down direction Z, the inner wall of the fitting groove 37 is in contact with the incorrect fitting-prevention rib 16 to regulate the displacement thereof. In this manner, by the incorrect fitting-prevention rib 16 configured to prevent the incorrect fitting of the first housing 10 and the second housing 20, it is possible to regulate the displacement of the front retainer 30.

Also, it is possible to correctly guide the male terminal (mating terminal) 13 into the terminal accommodation room 22 without colliding with the outside of the terminal insertion hole 33 by using the inclination surface 34 of the terminal insertion hole 33 formed in the front retainer 30 to guide the mating terminal. Also, at this time, as described above, the displacement of the front retainer 30 in the up-down direction Z is regulated due to the fitting of the fitting groove 37 and the incorrect fitting-prevention rib 16. Accordingly, the position of the inclination surface 34 with respect to the male terminal 13 is difficult to displace, and the terminal picking-up property, which is an accuracy of guiding the male terminal 13 by the inclination surface 34, can be improved. Although one embodiment of the present invention has been described above in detail with reference to the drawings, the specific structure is not limited to these embodiments, and design changes and the like being made without departing from the light of the present invention should also be included in the present invention.

### REFERENCE SIGNS LIST

1 fitting structure
10 first housing
11 accommodation portion
16 incorrect fitting-prevention rib
20 second housing
29 fitting concave portion
30 front retainer (incorrect fitting-prevention member)
37 fitting groove

What is claimed is:

1. A fitting structure for fitting a first housing of a first connector and a second housing of a second connector that is connected to the first connector along a fitting direction, the fitting structure comprising:
an accommodation portion and an incorrect fitting-prevention rib provided in the first housing, wherein
the accommodation portion opens in the fitting direction and is configured to accommodate the second housing, and
the incorrect fitting-prevention rib protrudes toward an inside of the accommodation portion and extends in the fitting direction;
a fitting concave portion provided in the second housing to be concave in a protrusion direction of the incorrect fitting-prevention rib; and
an incorrect fitting-prevention member attached to the second housing and including a fitting groove being concave in the protrusion direction,
wherein the fitting concave portion has a predetermined width in an intersection direction intersecting with the fitting direction and configured to receive the incorrect fitting-prevention rib inside the accommodation portion, and
the fitting groove and the incorrect fitting-prevention rib are fitted with each other within the width of the fitting concave portion.

2. The fitting structure according to claim 1, wherein the incorrect fitting-prevention member is a front retainer attached to an end portion at one side in the fitting direction of the second housing.

3. The fitting structure according to claim 2,
wherein the fitting concave portion is provided in a side portion of the second housing, and
the front retainer is attached to and detached from the second housing along the intersection direction.

4. The fitting structure according to claim 3,
wherein a terminal accommodation room in which a terminal is inserted in the fitting direction and accommodated therein is provided in the second housing,
a terminal insertion hole communicating with the terminal accommodation room from an outside is provided in the front retainer, and
an inclination surface for guiding a mating terminal connected to the terminal into the terminal insertion hole is provided in an opening edge portion of the terminal insertion hole.
